(19) United States
(12) Patent Application Publication
(10) Pub. No.: US 2019/0364256 A1
(43) Pub. Date: Nov. 28, 2019

(54) Method and System for Dynamically Generating Scene-Based Display Content on a Wearable Heads-Up Display

(71) Applicant: North Inc., Kitchener (CA)

(72) Inventors: Mathieu Boulanger, Kitchener (CA); David Vandervies, Waterloo (CA)

(21) Appl. No.: 16/409,974

(22) Filed: May 13, 2019

Related U.S. Application Data
(60) Provisional application No. 62/676,611, filed on May 25, 2018.

(51) Int. Cl. H04N 13/117; H04N 21/2187; H04N 13/139; H04N 13/383

(52) U.S. Cl. CPC H04N 13/117; H04N 13/383; H04N 13/139; H04N 21/2187

(57) ABSTRACT

System and methods are disclosed for dynamically generating scene-based content on a wearable heads-up display having a field of view. The method includes capturing a sequence of images of an environment of the wearable heads-up display, presenting the feed in a display space in the field of view of the wearable heads-up display, persistently displaying of the captured images in the display space in response to a scene selection request that identifies a selected scene, receiving a selection that indicates a target area in the persistently displayed captured image, processing the target area to identify one or more objects in the selected scene. Display content is generated based at least in part on the one or more objects identified in the selected scene. The display content is presented in the display space.

### CROSS-REFERENCE TO RELATED APPLICATIONS

This application claims the benefit of U.S. Provisional Application No. 62/676,611, filed 25 May 2018, titled “Method and System for Dynamically Generating Scene-Based Display Content on a Wearable Heads-Up Display”, the content of which is incorporated herein in its entirety by reference.

### TECHNICAL FIELD

The disclosure generally relates to dynamic content generation on a mobile electronic device and particularly to dynamic content generation on a wearable heads-up display.

### BACKGROUND

There is a new generation of wearable heads-up displays that can be worn on the head like conventional eyeglasses. These wearable heads-up displays are electronic devices that, when worn on the head of users, enable the users to see displayed content without preventing the users from seeing their environment. The ability to see both displayed content and the environment through the wearable heads-up display opens up opportunities to present intelligent content to the user based on the environment of the user. Intelligent content may be content that addresses a curiosity of the user about the environment or objects in the environment. There is a need in the art for a method and system for dynamically generating content on a wearable heads-up display.

### SUMMARY

A method of dynamically generating scene-based content on a wearable heads-up display having a field of view may be summarized as including capturing a sequence of images of a portion of an environment in which the wearable heads-up display is located; presenting a feed of the captured sequence of images in a display space in the field of view of the wearable heads-up display; in response to a scene selection request that identifies a selected scene, stopping the feed of the captured sequence of images with one of the captured images persistently presented in the display space in the field of view of the wearable heads-up display; receiving a selection that indicates a target area in the one of the captured images persistently presented in the display space in the field of view of the wearable heads-up display; causing image processing of the target area of the one of the captured images persistently presented in the display space in the field of view of the wearable heads-up display to identify one or more objects in the selected scene; generating a display content based at least in part on the one or more objects identified in the selected scene; and presenting the display content in the display space in the field of view of the wearable heads-up display. Presenting a feed of the captured sequence of images may include presenting a live feed of the captured sequence of images. Stopping the feed of the captured sequence of images with one of the captured images persistently presented in the display space may include determining which of the captured images from the feed was presented in the display space proximate a time at which the scene selection request was made or inferred.

The method may further include receiving the scene selection request from a wireless portable interface device in communication with the wearable heads-up display. Receiving a selection that indicates a target area of the one of the captured images persistently presented in the display space comprises presenting a selection window in the display space, the selection window overlaid on the one of the captured images persistently presented in the display space.

Receiving a selection that indicates a target area of the one of the captured images may further include responsively adjusting a size of the selection window in the display space. Responsively adjusting a size of the selection window in the display space may include automatically adjusting the size of the selection window until receiving a request to stop adjusting the size of the selection window. Presenting a selection window in the display space may include presenting the selection window centered at a target point in the display space, wherein the target point is based on a gaze point of a user of the wearable heads-up display in the display space. Causing image processing of the target area of the one of the captured images persistently presented in the display space may include causing processing of the target area by an object detection model running on a mobile device or in a cloud.

The method may further include presenting a set of use cases in the display space in the field of view of the wearable heads-up display.

The method may further include receiving a selection that indicates a target use case in the set of use cases, wherein causing image processing of the target area of the one of the captured images is based on the target use case.

A system for dynamically generating scene-based content on a wearable heads-up display having a field of view may be summarized as including a camera; a scanning laser projector comprising at least one visible laser diode and at least one scan mirror; a processor communicatively coupled to the scanning laser projector; a non-transitory processor-readable storage medium communicatively coupled to the processor, wherein the non-transitory processor readable storage medium stores data and/or processor-executable instructions that, when executed by the processor, cause the wearable heads-up display to: capture, by the camera, a sequence of images of a portion of an environment in which the wearable heads-up display is located; present, by the scanning laser projector, a feed of the captured sequence of images in a display space in the field of view of the wearable heads-up display; in response to a scene selection request that identifies a selected scene, stop, by the processor, the feed of the captured sequence of images with one of the captured images persistently presented in the display space in the field of view of the wearable heads-up display; receive, by the processor, a selection that indicates a target area in the one of the captured images persistently presented in the display space in the field of view of the wearable heads-up display; cause, by the processor, image processing of the target area of the one of the captured images persistently presented in the display space in the field of view of the wearable heads-up display to identify one or more objects in the selected scene; generate, by the processor, a display content based at least in part on the one or more objects identified in the selected scene; and present, by the scanning laser projector, the display content in the display space in the field of view of the wearable heads-up display.

The system may further include a support frame that in use is worn on a head of a user, wherein the scanning laser projector and processor are carried by the support frame.

The scanning laser projector may further include an infrared laser diode.

The system may further include an infrared detector carried by the support frame.

The non-transitory processor readable storage medium may store data and/or processor-executable instructions that, when executed by the processor, may further cause the wearable heads-up display to generate an infrared light by the infrared laser diode; scan the infrared light over an eye of a user by the at least one scan mirror; detect, by the infrared detector, reflections of the infrared light from the eye of the user; and determine, by the processor, a gaze point of the eye of the user in the display space from the reflections.

The system may further include a wireless portable device in communication with the wearable heads-up display to provide the scene selection request.

The foregoing general description and the following detailed description are exemplary of various embodiments of the invention(s) and are intended to provide an overview or framework for understanding the nature of the invention(s) as it is claimed. The accompanying drawings are included to provide further understanding of various embodiments of the invention(s) and are incorporated in and constitute part of this specification. The drawings illustrate various embodiments of the invention(s) and together with the description serve to explain the principles and operation of the invention(s).

### BRIEF DESCRIPTION OF DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Unless indicated otherwise, the particular shapes of the elements as drawn are not necessarily intended to convey any information regarding the actual shape of the particular elements and have been solely selected for ease of recognition in the drawing.

FIG. 1 is a front view of a wearable heads-up display.

FIG. 2 is a schematic diagram showing components of an exemplary wearable heads-up display.

FIG. 3 is a block diagram showing interaction between a scene app and select components of a wearable heads-up display.

FIG. 4 is a flow diagram showing an exemplary method of generating scene-based content.

FIG. 5A is a schematic of a display space containing a menu of apps.

FIG. 5B is a schematic of a display space containing a selected menu app icon.

FIG. 5C is a schematic of a display space containing a live feed of a video.

FIG. 5D is a schematic of a selection window overlaid on an image in a display space.

FIG. 5E is a schematic of a selection window containing a target area of an image in a display space.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices have not been shown or described in detail to avoid unnecessarily obscuring descriptions of the embodiments. For the sake of continuity, and in the interest of conciseness, same or similar reference characters may be used for same or similar objects in multiple figures. For the sake of brevity, the term “corresponding to” may be used to describe correspondence between features of different figures. When a feature in a first figure is described as corresponding to a feature in a second figure, the feature in the first figure is deemed to have the characteristics of the feature in the second figure, and vice versa, unless stated otherwise.

In this disclosure, unless the context requires otherwise, the word “comprise” and variations thereof, such as, “comprises” and “comprising” are to be construed in an open, inclusive sense, that is as “including, but not limited to.”

In this disclosure, reference to “one embodiment” or “an embodiment” means that a particular feature, structures, or characteristics may be combined in any suitable manner in one or more embodiments.

In this disclosure, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the disclosure provided herein are for convenience only and do not interpret the scope or meaning of the embodiments.

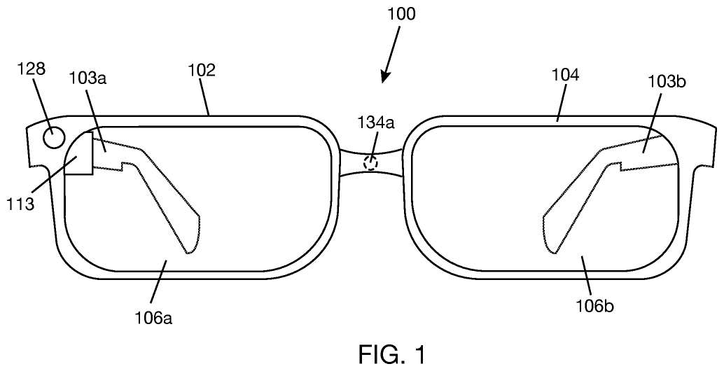

FIG. 1 illustrates an example wearable heads-up display 100 having a capability to dynamically generate content based on one or more scenes (“scene-based content”) in an environment of the user. Wearable heads-up display 100 is shown as having an appearance of eyeglasses. In general, the wearable heads-up displays contemplated in this disclosure may take on any form that enables a user to view display content without preventing the user from viewing the environment while the wearable heads-up display is worn on the head of the user. In one example, wearable heads-up display 100 includes a support frame 102 that carries the devices, electronics, and software that enable wearable heads-up display 100 to display content to a user. In one example, support frame 102 includes a frame front 104 carrying a pair of transparent lenses 106a, 106b and temples 103a, 103b attached to opposite sides of frame front 104. Many of the components of wearable heads-up display 100 are carried by or within temples 103a, 103b. Frame front 104 may include structures, such as conductors, to enable communication between components carried by or within temples 103a, 103b. Frame front 104 may also carry components of wearable heads-up display 100, such as a camera 128 and a proximity sensor 134a.

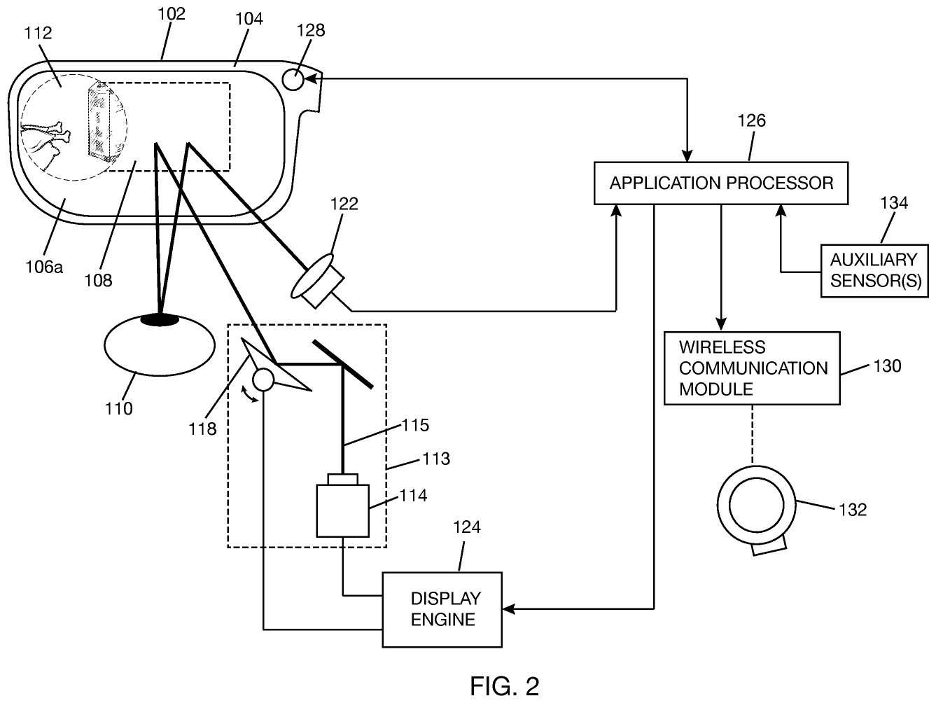

FIG. 2 illustrates components of wearable heads-up display 100, or a system for dynamically generating scene-based content positioned relative to an eye 110 of a user. In one implementation, wearable heads-up display 100 includes a scanning laser projector 113, which may be carried by the support frame 102. For example, scanning laser projector 113 may be carried by temple 103a (in FIG. 1). Scanning laser projector 113 includes a laser module 114 that is operable to generate infrared light and visible light and an optical scanner 118 that is operable to scan the infrared light and visible light over eye 110 of the user. Information derived from reflections of the infrared light from eye 110 may be used for tracking where eye 110 is gazing in a display space 112 in a field of view of the wearable heads-up display 100. The visible light may be used for displaying visible content to eye 110 in the display space 112.

Laser diode module 114 may have any number and combination of laser diodes to generate infrared light and visible light. In one example, laser module 114 includes an infrared laser diode (not shown separately) to generate infrared light and a plurality of visible laser diodes (not shown separately) to generate visible light in different narrow wavebands. As a further example, the visible laser diodes may include a red laser diode to generate red light, a green laser diode to generate green light, and a blue laser diode to generate blue light. laser module 114 may include optics to combine the output beams of the multiple laser diodes into a single combined beam 115. At any given time, depending on what the system requires, the beam 115 coming out of laser module 114 may include a combination of infrared light and visible light (to allow eye tracking and content display), infrared light alone (to allow eye tracking alone), or visible light alone (to allow content display alone).

Optical scanner 118 is positioned, oriented, and operable to receive laser beam 115 from laser module 114. Optical scanner 118 scans laser beam 115, directly or indirectly, across eye 110. In one implementation, optical scanner 118 includes at least one scan mirror. In one example optical scanner 118 may be a two-dimensional scan mirror operable to scan in two directions, for example, by oscillating or rotating with respect to two axes. In another example, scan mirror 118 may include two orthogonally-oriented mono-axis mirrors, each of which oscillates or rotates about its respective axis. The mirror(s) of optical scanner 118 may be microelectromechanical systems (MEMS) mirrors, piezoelectric mirrors, and the like. In operation, optical scanner or scan mirror(s) 118 scans laser beam 115 over eye 110 by sweeping through a range of scan orientations. For each scan orientation, scan mirror(s) 118 receives laser beam 115 from laser module 114 and reflects laser beam 115 into a respective region of eye 110. In other implementations, optical scanner 118 may be a mirrorless optical scanner, such as a fiber optic scanner, or a combination of mirror and mirrorless optical scanning elements.

In one implementation, optical scanner 118 does not scan laser beam 115 directly over eye 110. Instead, optical scanner 118 directs laser beam 115 to a transparent combiner 108 integrated into lens 106a, and transparent combiner 108 redirects the laser beam 115 that it receives to eye 110. In one example, transparent combiner 108 is a wavelength-multiplexed holographic optical element that selectively responds to different wavelengths of light. In general, a holographic optical element is an optical element that is produced using holographic principles and processes. In one implementation, the wavelength-multiplexed holographic optical element used as transparent combiner 108 includes at least one visible hologram that is responsive to infrared light and unresponsive to visible light and at least one infrared hologram that is responsive to infrared light and unresponsive to visible light. “Responsive,” herein, means that the hologram redirects at least a portion of the light, where the magnitude of the portion depends on the playback efficiency of the hologram. “Unresponsive,” herein, means that the hologram transmits the light, generally without modifying the light. The holograms are encoded, carried, embedded in or on, or otherwise generally included in a single volume of holographic material, e.g., photopolymer and/or a silver halide compound. In another implementation, transparent combiner 108 may be a waveguide, or light guide, with an in-coupler and out-coupler for coupling light into and out of the waveguide.

Wearable heads-up display 100 includes a display engine 124 to translate display data into drive signals for laser module 114 and optical scanner 118. The drive signals for laser module 114 represent content to be displayed in display space 112—for example, a drive signal may indicate which laser diode (or laser source) should be on and at what optical power for a particular pixel to be displayed. In operation, visible light generated by laser module 114 is modulated based on the drive signals—the infrared light generated by laser module 114 may be similarly modulated; however, the infrared light will not be visible to the eye. The modulated laser light is scanned directly onto the retina of eye 110 by the optical scanner 118, and transparent combiner 108, to create an image of the display content on the retina.

When the laser light is scanned onto the retina of eye 110, the user will have a perception of seeing an image on a display screen floating in space. However, in reality, the image is on the retina of eye 110 and not on a display screen—there is no display screen in the traditional sense. For illustration purposes, display space 112 represents what a user may perceive. Display space 112 is shown overlapping lens 106a. However, this does not suggest that display space 112 is a display screen that is integrated into lens 106a. In this context, display space 112 may be regarded as a space in the field of view of the wearable heads-up display, or in the field of view of eye 110, where display content projected by the scanning laser projector 113 may appear to be seen by the user. The display space 112 will appear to be at some distance in front of the lens 106a rather than in the plane of the lens 106a.

Display engine 124 may be communicatively coupled to an application processor 126, which is a chip that runs the operating system and applications software of wearable heads-up display. In one implementation, application processor 126 runs a scene application (“scene app”) that dynamically generates content based on scenes in the environment of the user. The scene app may be started in the application processor 126 in response to a request from a user of the wearable heads-up display or may be started in response to behavior of the user, e.g., if it appears that the user is curious about a scene in the environment. The scene app generates content based on scenes in the environment of the user and provides the generated content to the display engine 124 for presentation in the display space 112. Camera 128 coupled to support frame 102 is positioned to capture scenes in front of the user. Camera 128 includes an optical sensor (or image sensor), such as a CMOS sensor, and may include one or more lenses for coupling light into the optical sensor. Camera 128 is communicatively coupled to the applications processor 126 to provide camera data to the scene app, which the scene app may use for one or more acts of dynamically generating scene-based content.

The scene app may use gaze point of the user in the display space 112 to inform decisions about dynamic content generation. To this end, wearable heads-up display 100 may include an infrared detector 122 to detect reflections of infrared light from eye 110. The detected reflections of infrared light may be used for eye tracking. In general, an infrared detector is a device that is sensitive to and responsive to infrared light and that provides signals responsive to sensing or detecting infrared light. In one example, infrared detector 122 is a single photodiode sensor or photodetector that is responsive to infrared light. In another example, infrared detector 122 may be an array of photodetectors that are responsive to infrared light or a complementary metal-oxide semiconductor (CMOS) camera having an array of sensors that are responsive to light in the infrared range. Wearable heads-up display 100 may include one or a plurality of infrared detectors 122. Infrared detector 122 is positioned to detect reflections of infrared light from eye 110, e.g., by detecting reflections of infrared light directly from eye 110 and/or directly from transparent combiner 108, which is positioned to receive reflections of infrared light from eye 110. Infrared detector 122 is carried by support frame 102 of wearable heads-up display. For example, infrared detector 122 may be carried by temple 103a (in FIG. 1) or may be carried by frame front 104 (in FIG. 1).

The scene app may include eye tracking logic to determine a gaze point of the user from the reflections of infrared light detected by infrared detector 122. In general, any method of obtaining the gaze point from detected reflections of infrared light may be used. In one example, the eye tracking logic may determine a glint position from the detected reflections (e.g., the specular portion of the detected reflections) and map the glint position to a gaze point in display space 112. In determining a glint position from the detected reflections, the eye tracking logic may determine the glint position by sampling and processing the output of the infrared detector 122, or the eye tracking logic may receive the glint position from an edge detection device (not shown) that detects glints from the output signal of infrared detector 122. In another example, the eye tracking logic may determine glint and pupil positions from the detected reflections of infrared light, determine a glint-pupil vector from glint-pupil vector positions, and map the glint-pupil vector to a gaze point in display space 112. In another example, the eye tracking logic may switch between tracking the eye by glint position and tracking the eye by glint-pupil vector or may combine tracking the eye by glint position and glint-pupil vector. Examples of methods of tracking eye gaze by glint position and/or glint-pupil vector are disclosed in U.S. Provisional Application Nos. 62/658,436, 62/658,434, and 62/658,431 (or U.S. application Ser. Nos. 16/376,604, 16/376,674, and 16/376,319, respectively), the disclosures of which are incorporated herein by reference.

Wearable heads-up display 100 may include a wireless communication module 130 to enable wireless connectivity with external devices and systems. For example, wireless communication module 130 may enable Wi-Fi connectivity, Bluetooth connectivity, and/or other connectivity based on known wireless network standards. The wireless communication module 130 may include or comprise one or more radios (e.g., transmitters, receivers, transceivers, and associated antennas).

In one example application processor 126 may communicate with a wireless portable interface device 132 through wireless communication module 130. The user may use wireless portable interface device 132 to interact with display content in display 112 and cause the system to take an action. An example of a wireless portable interface device is described in U.S. patent application Ser. No. 15/282,535, the disclosure of which is incorporated herein by reference. However, the user is not limited to interacting with display content in display 112, or with wearable heads-up display 100 in general, through wireless portable interface device 132. For example, the user interact may interact with content in display 112, or with wearable heads-up display 100 in general, by audio input, by eye gaze input, by touch input, and the like. Thus, wearable heads-up display 100 may include the appropriate interfaces to enable communication with application processor 126 by these alternative methods.

Application processor 126 may be communicatively coupled to one or more auxiliary sensors 134. Examples of auxiliary sensors 134 that may be communicatively coupled to application processor 126 include, but are not limited to, proximity sensors, motion sensors, e.g., inertial motion units, accelerometers, gyroscopes, and GPS sensors. As an example, FIG. 1 shows a proximity sensor 134a coupled to frame front 104. In one example, proximity sensor 134a may measure a relative position of wearable heads-up display 100 to a point on the head of the user. Proximity sensor data may be used to correct gaze point in eye tracking due to shifts in position of wearable heads-up display 100 relative to the head, as described, for example, in U.S. Provisional Application No. 62/658,434 (or U.S. patent application Ser. No. 16/376,674), or for other purposes, e.g., in processing of optical sensor signals from camera 128.

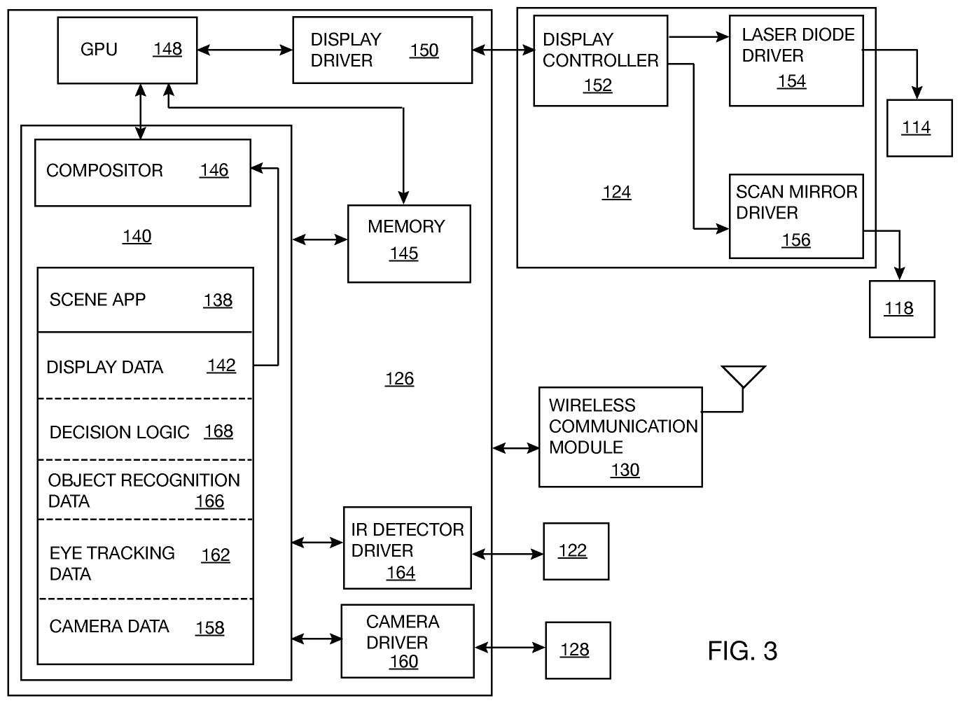

FIG. 3 is a block diagram showing the scene app, identified as 138, interacting with application processor 126 and other select components of wearable heads-up display according to one illustrated implementation. In the example shown in FIG. 3, a processor 140 is executing the instructions of scene app 138. Processor 140 may be a general-purpose processor that performs computational operations. For example, processor 140 may be a central processing unit (CPU), such as a microprocessor, a controller, an application specific integrated circuit (ASIC), or a field-programmable gate array (FGPA). Processor 140 may retrieve the instructions of scene app 138 from memory 145. Memory 145 is a non-transitory processor-readable storage medium that stores data and instructions for application processor 126. Memory 145 may include one or more of random-access memory (RAM), read-only memory (ROM), Flash memory, solid state drive, or other processor-readable storage medium.

According to one illustrated implementation, if content is to be presented in display space 112 (in FIG. 2), scene app 138 sends display data 142 to a compositor 146, which composes the display data to a form understandable by a GPU 148. GPU 148 receives the display data from compositor 146 and writes the display data into a frame buffer, which is transmitted, through display driver 150, to display controller 152 of display engine 124. Display controller 152 provides the display data to laser diode driver 154 and sync controls to scan mirror driver 156. Laser diode driver 154 modulates the visible laser diodes in the laser module 114 according to the display data. Scan mirror driver 156 applies driving voltage to the scan mirror(s) of the optical scanner 118 so that the laser beam provided by the laser module 114 lands on the correct spot in the display space 112.

Scene app 138 may receive camera data 158 from camera 128. Application processor 126 may include a camera driver 160 to enable scene app 138 to receive camera data 158. Camera driver 130 may convert optical sensor signals from camera 128 into image data that is received as camera data 158. Scene app 138 may retrieve portions of the camera data 158 into the display data that is to be presented in display space 112.

Scene app 138 may receive eye tracking data 162 from infrared detector 122. Application processor 126 may include an infrared (IR) detector driver 164 to enable scene app 138 to receive eye tracking data 162. In one example, IR detector driver 164 may include an edge detection device that detects glint and/or pupil from the output signal of the infrared detector 122 and provides the glint and/or pupil information as the eye tracking data. Alternatively, the IR detector driver 164 may provide the detector signal as eye tracking data.

Scene app 138 may receive objection recognition data 166 from an external device or network over a wireless connection. Wireless communication module 130 may provide the wireless connection.

Scene app 138 includes decision logic 168, which when executed by a processor enables scene app 138 to dynamically generate scene-based content.

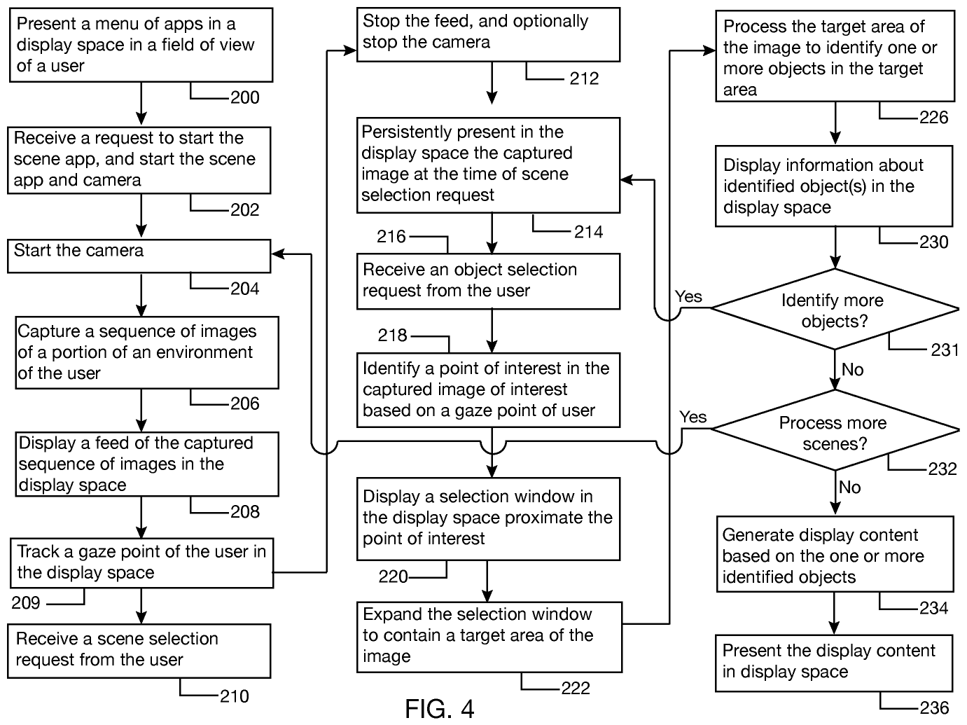

FIG. 4 is a flowchart illustrating a method of generating scene-based content on a wearable heads-up display (corresponding to decision logic 168 in FIG. 3) of scene app 138 according to at least one illustrated implementation. The flowchart is presented from the viewpoint of the wearable heads-up display, or from the viewpoint of an application (app) (e.g., set of processor-executable instructions, running on the wearable heads-up display (see FIG. 3). However, interaction of the user with the wearable heads-up display will be described to provide a full context for how the method works.

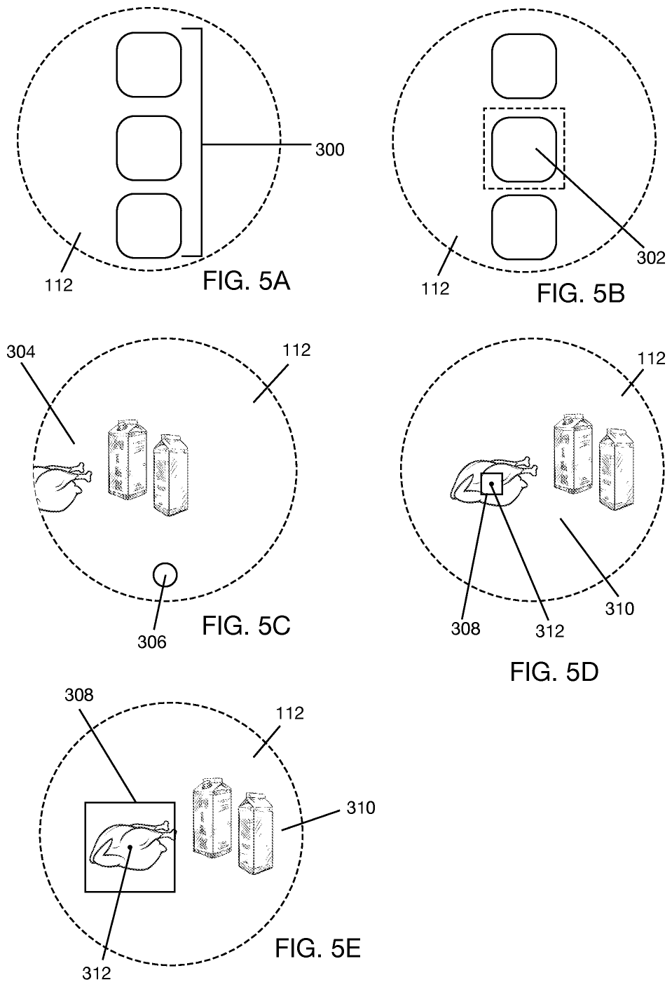

At the start of the method, a user is wearing a wearable heads-up display on the head, and the user wishes to have scene-based content generated and shown in a display space formed in a field of view of the user by the wearable heads-up display. In one implementation, at 200, the system presents a menu of apps in the display space. (For illustration purposes only, FIG. 5A shows an example of a menu 300 of app icons in display space 112). The system may present the menu of apps in response to an interaction of the user with the wearable heads-up display. In one example, the menu of apps includes, among others, a scene app that generates content based on one or more scenes seen by a camera of the wearable heads-up display. In one scenario, the user selects the scene app from the menu. (For illustration purposes only, FIG. 5B shows a selected app icon 302 in display space 112.) In one example, the user may select the scene app using a portable interface device that communicates wirelessly with the wearable heads-up display. In another example, the user may select the scene app by tapping on a surface of the wearable heads-up display or by focusing an eye on an icon representing the scene app or by saying the name of the app or by other gesture that the system recognizes for selecting an app from a menu of apps displayed in the display space. Upon the user selecting the scene app, at 202, the system receives the request to start the scene app and starts the scene app.

At 204, when the scene app is started, the scene app sends a request to the camera driver (160 in FIG. 3) to start the camera (128 in FIGS. 2 and 3). At 206, the scene app sends a request to the camera through the camera driver to start capturing a sequence of images in the environment of the user. The sequence of images may be in the form of a sequence of still images or in the form of a video. It should be noted that the requests of 204 and 206 may be combined into a single request. The captured images are images of scenes viewable from the camera while the user is wearing the wearable heads-up display. The camera returns the camera data to the camera driver 160 (in FIG. 3), which provides the camera data 158 (in FIG. 3) to the scene app. The camera driver may process the raw data received from the camera into image data that is usable by scene app. At 208, the scene app displays a feed of the captured sequence of the images in the display space 112 (in FIG. 2). The scene app sends the images received from the camera 128 to the display engine (24 in FIG. 3), which controls the laser module (114 in FIGS. 2 and 3) and optical scanner (118 in FIGS. 2 and 3) (or more generally the projector of the wearable heads-up display) to display the images in the display space. The scene app displays a feed of the captured sequence of the images in the display space. In one implementation, the feed may be a live feed, i.e., the images are displayed in the display space as they are captured by the camera. (For illustration purposes only, FIG. 5C shows a live feed 304 of captured images in display space 112. An indicator 306 may show that the camera is on and is capturing images.) At 209, the scene app may also start receiving eye tracking data from IR detector driver (164 in FIG. 3). The scene app may determine the gaze point of the user in the display space based on the eye tracking data received.

The user watches the feed of the captured sequence of images in the display space. In one example, the user sees the feed in the display space while viewing the environment through the wearable heads-up display. When a scene of interest appears in the display space, the user may send a request to the scene app to select the scene. The user may send the scene selection request through interaction with the portable interface device while the scene of interest is shown in the display space. For example, the user may activate a button on the portable interface device that causes the portable interface device to generate a scene selection request that is received by the scene app through the wireless receiver of the wearable heads-up display. Alternatively, other methods of indicating interest in the current scene, such as voice command, gesture command, and the like, may be used to send a scene selection request to the scene app. Alternatively, the scene app may infer the scene selection request from the behavior of the user. For example, the scene app may detect that the output of a motion sensor carried by the wearable heads-up display is not changing, which may indicate that the user is fixated on a certain scene in the environment.

At 210, the scene app receives, or infers, the scene selection request. At 212, upon receiving, or inferring, the scene selection request, the scene app stops sending images of the camera to present in the display space and may send a request to the camera to stop capturing images. At 214, the captured image corresponding to the time the scene selection request was made, or inferred, is persistently shown in the display space. This may occur automatically by stopping the feed of the captured images, or the scene app may send the captured image corresponding to a time proximate when the scene selection request was made, or inferred, to the display space.

The user may view the target captured image shown in the display space and may indicate to the scene app a desire to explore object(s) in the image. At 216, the scene app receives an object selection request. The object selection request may be generated when the user interacts with the portable interface device while gazing at a spot on the image. The user may interact with the portable interface device, e.g., by activating a button on the portable interface device, to cause the portable interface device to transmit a request signal to the wireless receiver of the wearable heads-up display. At 218, the scene app obtains the gaze point of the user in the display space proximate a time at which the object selection request was made—mainly, the gaze point should be representative of where the user was looking in the display space when the user made the object selection request. The scene app may obtain the gaze point from the eye tracking data. At 220, the scene app causes a selection window to be overlaid on the target captured image in the display space. This may include sending the selection window to the display space without first clearing the display space or sending both the target captured image and selection window to the display space. In one example, the scene app centers the selection window at or proximate the gaze point. (For illustration purposes only, FIG. 5D shows a selection window 308 overlaid on a target captured image 310 in the display space 112 and centered at a gaze point 312.) In one implementation, the scene app may also zoom into the area of the image around the gaze point, e.g., to make it easier for the user to select objects in the image through the selection window.

In one implementation, the selection window is initially small when it is overlaid on the target captured image in the display space at 220. At 222, the scene app expands the selection window to contain a target area of the image. The expansion may be proportionally about the gaze point, or about whatever point the selection window was centered when the selection window was first overlaid on the image at 220. In one example, after the scene app centers the selection window proximate the gaze point, the scene app starts automatically expanding the selection window. The scene app expands the selection window until a request is received to stop expansion of the window or when the window touches a boundary of the image. In one example, the request to stop expansion of the selection window comes from the user. For example, the user makes a request to stop expansion of the window when the window contains a sufficient area of the image including the object(s) that the user wishes to identify or base generation of scene-based content on. The user may make the request to stop expansion of the window using, for example, the portable interface device or by other interaction methods, such as voice command or recognized gesture command. (For illustration purposes only, FIG. 5E shows selection window 308 expanded to contain a target area of image 310 in display space 112.) In another implementation, the selection window may be initially large when it is overlaid on the image in the display space. In this case, instead of expanding the selection window at 222, the selection window may be shrunk down to contain the target area of the image. The shrinking may also be proportionally about the gaze point, or whatever point the selection window was centered on when first overlaid on the image. Each adjustment of the selection window may involve redrawing the display space through the display engine and scanning laser projector.

In one implementation, a request to stop adjustment, e.g., expansion or shrinkage, of the selection window begins a process of analyzing the scene to identify objects. At 226, the scene app processes the target area of the image contained within the selection window to identify one or more objects in the target area. In one example, because object recognition tends to be computationally intensive, the scene app processes the target area of the captured image by sending a request to an external device or system to process the target area of the captured image.

In one implementation, the scene app transfers the captured image, or at least the target area of the captured image, to a mobile computing device, such as a smart phone or tablet, over a wireless connection, such as a Bluetooth classic or Bluetooth Low Energy (BLE) connection. An object detection model, e.g., MobileNet SSD model, running on the mobile device processes the target area to identify one or more objects in the target area. For each identified object, the object detection model outputs object identity and coordinates (“object recognition data”). The mobile device then transfers the output of the model back to the scene app over the wireless connection.

In another implementation, the scene app transfers the captured image, or at least the target area of the captured image, to a mobile computing device, such as a smart phone or tablet, over a wireless connection, such as Bluetooth classic or Bluetooth Low Energy (BLE) connection. The mobile computing device then transmits the captured image/target area of captured image to the cloud through a WebSocket. An object detection model running in the cloud, such as Google Cloud Vision, processes the target area to identify one or more objects in the target area. For each identified object, the object detection model outputs identity and coordinates of the object (“object recognition data”). The output of the model is transferred back to the mobile computing device through the WebSocket. The mobile computing device then transfers the output of the model back to the scene app over the wireless connection.

At 230, the scene app may display the identified objects, or information about the identified objects, in the display space. At 231, the scene app may ask if the user wishes to select additional objects in the current scene, e.g., by requesting the display engine to display an appropriate question and “yes” and “no” buttons, or equivalently phrased buttons, in the display space. If the user wishes to process additional objects in the current scene, acts 216 through 230 are repeated. If the user does not wish to process additional objects in the scene, at 232, the scene app may ask if the user wishes to process additional scenes, e.g., by requesting the display engine to display an appropriate question and “yes” and “no” buttons, or equivalently phrased buttons, in the display space. If the user wishes to process additional scenes, acts 206 through 230 are repeated. If the user does not wish to process additional scenes, at 234, the scene app generates scene-based content based on the identified objects. At 236, the scene app may update the display space with the scene-based content. The scene app may also store the scene-based content in the memory of the wearable heads-up display for later use.

In general, objection detection models detect object characteristics such as shapes, colors, textures, and/or patterns from an image. The detected object characteristics are compared to a database of objects to determine if there is a match between the detected object characteristics and objects in the database. The object detection model may be trained to recognize particular objects, such as faces or symbols. Thus, it may be useful to have an indication of the objects the user is interested in and use this information to drive both recognition of objects from captured images of scenes and generation of content based on the objects.

In one implementation, the scene app may include a menu of use cases that can be presented to the user in the display space through the display engine and projector. For illustration purposes, examples of use cases may include, but are not limited to, recipe, machine-readable symbol (e.g., barcode symbol), artifact, face, and translation use cases. For example, a recipe use case may involve selecting edible items in scenes and suggesting recipes based on the edible items. A machine-readable symbol (e.g., barcode symbol) use case may involve selecting an object in a scene and providing information about the object based on the barcode. An artifact use case may involve identifying an artifact, such as a historical building, in a scene and providing information about the artifact. A face use case may involve identifying a face in a scene and providing information about the face. A translation use case may involve identifying a word or phrase in a scene and translating the word or phrase into a language of the user.

In one implementation, shortly after the scene app is started, the scene app may request the display engine to display the menu of use cases in the display space. The user may select a use case from the menu, in which case the scene app can use the selected use case to drive identification of objects in scenes. For example, if the user selects a recipe use case, then the objects identified from the scene at 226 may be limited to objects that are edible. Or, if the user wishes to identify an artifact, then the scene app may collect geolocation information to assist in identifying the artifact. Or, if the user wishes to identify a face, then the scene app may detect an event occurring in the environment of the user to assist in identifying which information about the face might be useful to the user. In addition, the scene app may generate scene-based content from the identified objects consistent with the selected use case.

The foregoing detailed description has set forth various implementations or embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this disclosure, a “non-transitory processor-readable medium” or “non-transitory computer-readable memory” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples of the processor-readable medium are a portable computer diskette (magnetic, compact flash card, secure digital, or the like), a random-access memory (RAM), a read-only memory (ROM), an erasable programmable read-only memory (EPROM, EEPROM, or Flash memory), a portable compact disc read-only memory (CDROM), digital tape, and other non-transitory medium.

The above description of illustrated implementations or embodiments, including what is described in the Abstract of the disclosure, is not intended to be exhaustive or to limit the implementations or embodiments to the precise forms disclosed. Although specific implementations or embodiments and examples are described herein for illustrative purposes, various equivalent modifications can be made without departing from the spirit and scope of the disclosure, as will be recognized by those skilled in the relevant art. The teachings provided herein of the various implementations or embodiments can be applied to other portable and/or wearable electronic devices, not necessarily the exemplary wearable electronic devices generally described above.

1. A method of dynamically generating scene-based content on a wearable heads-up display having a field of view, comprising:
capturing a sequence of images of a portion of an environment in which the wearable heads-up display is located;
presenting a feed of the captured sequence of images in a display space in the field of view of the wearable heads-up display;
in response to a scene selection request that identifies a selected scene, stopping the feed of the captured sequence of images with one of the captured images persistently presented in the display space in the field of view of the wearable heads-up display;
receiving a selection that indicates a target area in the one of the captured images persistently presented in the display space in the field of view of the wearable heads-up display;
causing image processing of the target area of the one of the captured images persistently presented in the display space in the field of view of the wearable heads-up display to identify one or more objects in the selected scene;
generating a display content based at least in part on the one or more objects identified in the selected scene; and
presenting the display content in the display space in the field of view of the wearable heads-up display.

2. The method of claim 1, wherein presenting a feed of the captured sequence of images comprises presenting a live feed of the captured sequence of images.

3. The method of claim 1, wherein stopping the feed of the captured sequence of images with one of the captured images persistently presented in the display space comprises determining which of the captured images from the feed was presented in the display space proximate a time at which the scene selection request was made or inferred.

4. The method of claim 3, further comprising receiving the scene selection request from a wireless portable interface device in communication with the wearable heads-up display.

5. The method of claim 1, wherein receiving a selection that indicates a target area of the one of the captured images persistently presented in the display space comprises presenting a selection window in the display space, the selection window overlaid on the one of the captured images persistently presented in the display space.

6. The method of claim 5, wherein receiving a selection that indicates a target area of the one of the captured images further comprises responsively adjusting a size of the selection window in the display space.

7. The method of claim 6, wherein responsively adjusting a size of the selection window in the display space comprises automatically adjusting the size of the selection window until receiving a request to stop adjusting the size of the selection window.

8. The method of claim 7, wherein presenting a selection window in the display space comprises presenting the selection window centered at a target point in the display space, wherein the target point is based on a gaze point of a user of the wearable heads-up display in the display space.

9. The method of claim 1, wherein causing image processing of the target area of the one of the captured images persistently presented in the display space comprises causing processing of the target area by an object detection model running on a mobile device or in a cloud.

10. The method of claim 1, further comprising presenting a set of use cases in the display space in the field of view of the wearable heads-up display.

11. The method of claim 10, further comprising receiving a selection that indicates a target use case in the set of use cases, wherein causing image processing of the target area of the one of the captured images is based on the target use case.

12. A system for dynamically generating scene-based content on a wearable heads-up display having a field of view, comprising:
a camera;
a scanning laser projector comprising at least one visible laser diode and at least one scan mirror;
a processor communicatively coupled to the scanning laser projector;
a non-transitory processor-readable storage medium communicatively coupled to the processor, wherein the non-transitory processor readable storage medium stores data and/or processor-executable instructions that, when executed by the processor, cause the wearable heads-up display to:
capture, by the camera, a sequence of images of a portion of an environment in which the wearable heads-up display is located;
present, by the scanning laser projector, a feed of the captured sequence of images in a display space in the field of view of the wearable heads-up display;
in response to a scene selection request that identifies a selected scene, stop, by the processor, the feed of the captured sequence of images with one of the captured images persistently presented in the display space in the field of view of the wearable heads-up display;
receive, by the processor, a selection that indicates a target area in the one of the captured images persistently presented in the display space in the field of view of the wearable heads-up display;
cause, by the processor, image processing of the target area of the one of the captured images persistently presented in the display space in the field of view of the wearable heads-up display to identify one or more objects in the selected scene;
generate, by the processor, a display content based at least in part on the one or more objects identified in the selected scene; and
present, by the scanning laser projector, the display content in the display space in the field of view of the wearable heads-up display.

13. The system of claim 12, further comprising a support frame that in use is worn on a head of a user, wherein the scanning laser projector and processor are carried by the support frame.

14. The system of claim 13, wherein the scanning laser projector further comprises an infrared laser diode.

15. The system of claim 14, further comprising an infrared detector carried by the support frame.

16. The system of claim 15, wherein the non-transitory processor readable storage medium stores data and/or processor-executable instructions that, when executed by the processor, further cause the wearable heads-up display to:
generate an infrared light by the infrared laser diode;
scan the infrared light over an eye of a user by the at least one scan mirror;
detect, by the infrared detector, reflections of the infrared light from the eye of the user; and
determine, by the processor, a gaze point of the eye of the user in the display space from the reflections.

17. The system of claim 12, further comprising a wireless portable interface device communicatively coupled to the processor.
